(19) United States
(12) Patent Application Publication
(10) Pub. No.: US 2016/0275807 A1
(43) Pub. Date: Sep. 22, 2016

(54) COMPUTER AND MOBILE END CLASSROOM INTERACTIVE ANSWERING METHOD AND DEVICE BASED ON TWO-DIMENSIONAL CODE

(71) Applicant: SHANGHAI NETBAN EDUCATION TECHNOLOGY COMPANY LIMITED, Shanghai (CN)

(72) Inventor: Jianbiao DAI, Shanghai (CN)

(21) Appl. No.: 14/668,267

(22) Filed: Mar. 25, 2015

(30) Foreign Application Priority Data
Mar. 16, 2015 (CN) 201510114496.X

(51) Int. Cl. G09B 7/06

(52) U.S. Cl. CPC G09B 7/06

(57) ABSTRACT

The present invention relates to a method and device of interactive answering between computer end and mobile end in classroom based on a two-dimensional code technology. A computer end with screen generates a teaching-used web page having question and answer option buttons, and a two-dimensional code including the address of the web page is displayed on the web page; students use mobile ends to scan the two-dimensional code, then enter the web page corresponding to the internet address and display an answering page; the mobile ends answer a question on the page online by inputting; and the computer end counts and displays answering results of the mobile ends. Compared with the prior art, the present invention realizes connection and interaction between a large electronic screen and mobile terminal equipment of students in a classroom.

### FIELD OF THE INVENTION

The present invention relates to the field of computers and mobile internet, and particularly relates to a computer end and mobile end classroom interactive answering method and device based on a two-dimensional code.

### BACKGROUND OF THE INVENTION

Two-dimensional code technology has been increasingly applied in the society, and particularly attracts more and more attention in the field of mobile internet. Nearly all smart phone terminals can realize applications of scanning two-dimensional codes, e.g. WeChat, MicroBlog, Alipay and a large amount of dedicated bar code applications. People can conveniently enter specified internet address interfaces by scanning two-dimensional codes through these applications.

A large computer screen is common equipment in the fields of school teaching and training of enterprises and institutions and can be operated by touching or through a mouse, a teacher carries out teaching on a subject by presenting various textual and graphic materials or web page information on the large computer screen, and a teacher also often presents questions raised to students through the large computer screen on the platform and expects to collect answers from the students. However, no matter the computer displays general normal office documents or web pages or common Microsoft PowerPoint projection files or WPS projection files, associated interaction can not be formed between the large computer screen and the students in a classroom at present. For example, when a choice question is displayed on the computer interface, all the students in the class can not simultaneously answer the question displayed on the large computer screen online. On the one hand, due to a distance factor, the students can not operate the large computer screen by their hands; and on the other hand, as there is more than one student but only one large computer screen, different students can not be distinguished by the large computer screen and for the question displayed thereon.

### SUMMARY OF THE INVENTION

The object of the present invention is to provide a computer and mobile end classroom interactive answering method and device based on a two-dimensional code for overcoming the above shortcomings in the prior art. By adopting two-dimensional code technology, connection between a computer end and a mobile end is established in such a manner that the mobile end scans a two-dimensional code on the computer end in a class, so that interaction between the mobile end and the computer end and on-line answering in the class are realized.

The object of the present invention can be realized through the following technical solution.

A computer and mobile end classroom interactive answering method based on a two-dimensional code, characterized by comprising the following steps:
1) a computer end generating a teaching-used web page having question and answer option buttons;
2) displaying a two-dimensional code including the address of the web page on the web page;
3) mobile ends scanning the two-dimensional code, entering the web page corresponding to the address and displaying an answering page;
4) students clicking an answering button on the page displayed by the mobile ends to answer a question on the page of the computer end online; and
5) the computer end counting and displaying answering results of the mobile ends.

Preferably, the teaching-used web page is generated through a normal web page editor, and the question is a true or false question, choice question with single correct option or choice question with multiple correct options.

Preferably, the two-dimensional code is popped up through a specified button on the page and displayed.

Preferably, the mobile ends acquire the two-dimensional code of the computer end through a two-dimensional code scanning application.

Preferably, the two-dimensional code scanning application is WeChat, MicroBlog, built-in RichScan or any other two-dimensional code scanning application.

Preferably, the mobile ends are mobile phones or PADs.

A computer and mobile end classroom interactive answering device based on a two-dimensional code, characterized by comprising a computer end, mobile ends and a communication network, wherein the mobile ends are connected with the computer end through the communication network, the computer end is provided with a teaching-used web page having question and answer option buttons and a two-dimensional code including the address of the web page, and the mobile ends are provided with a two-dimensional code scanning application for acquiring web page information of the computer end and answering a question on the web page online.

Preferably, the communication network is internet.

Compared with the prior art, in the present invention, the two-dimensional code technology is applied to class interaction for the first time, thus solving the problem that the large computer screen can only be used for displaying contents (namely transmitting information to students in one way, but can not realize interactive answering between a teacher and students) in the prior art, and realizing connection and interaction between a large electronic screen and mobile terminal equipment of students in a class.

### BRIEF DESCRIPTION OF THE DRAWINGS

FIG. 1 is a structural schematic diagram of the present invention.

### DETAILED DESCRIPTION OF THE EMBODIMENTS

The present invention will be described in detail below in conjunction with the accompanying drawing and a specific embodiment.

### Embodiment

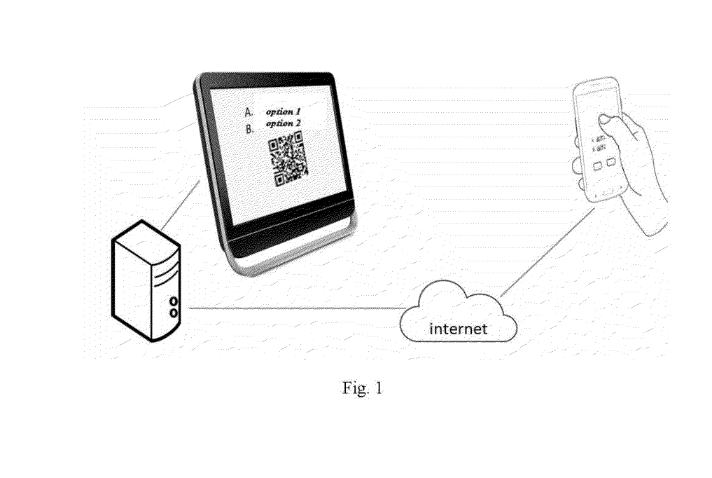

As shown in FIG. 1, a computer end carries out computation of a question web page program, a large display screen is used for displaying a question page, and a displayed two-dimensional code includes address information of a web page of a questions asked by a teacher. After a mobile phone or pad scans the two-dimensional code, the question page can be logged on the mobile phone or pad, the questions asked by the teacher can be seen, and the question can be answered by clicking a corresponding button of the page on the mobile phone or pad.

An implementation method of the present invention will be introduced in detail below.

Step 1, this system provides a web page editor to a teacher for editing an on-line question. The web page editor carries out editing with universal web page scripts, the teacher can edit an interactive question (mainly objective question such as choice question and true or false question) in a class in a similar manner as editing an Microsoft office document, and the question page is displayed.

Step 2, the system automatically converts the web page address of the question page into a standard two-dimensional code image by adopting an open-source standard two-dimensional code conversion code. A two-dimensional code trigger button is placed on an unobvious position of the question page, and the two-dimensional code image can be popped up on the page by clicking the trigger button.

Step 3, the teacher displays the question page on a large computer screen of a classroom platform, and then clicks the trigger button to display the two-dimensional code image on the large screen.

Step 4, mobile phones or Pads for students need to be installed with two-dimensional code scanning application like WeChat, MicroBlog or any RichScan application provided by this system. The RichScan function is enabled to scan the two-dimensional code displayed on the page of the teacher's large computer screen, and then a question and answer button page set by the teacher can be popped up on the mobile phones. Students can click the button to answer the question online.

Step 5, after a backend of this system collects answer data of students' mobile phone ends through the internet, answers can be counted, possibly by simple accumulation, and the number of students of each option of the choice question or true or false question is calculated.

Step 6, the teacher clicks a count button on the large computer screen, and counting result data mentioned in the previous step can be displayed on the large computer screen.

1. A computer and mobile end classroom interactive answering method based on a two-dimensional code, comprising the following steps:
1) a computer end with screen generating a teaching-used web page having question and answer option buttons;
2) displaying a two-dimensional code including the address of the web page on the web page of the computer end;
3) students use mobile ends scan the two-dimensional code, entering the web page corresponding to the address and displaying an answering page;
4) the mobile ends answering a question on the page online by inputting or clicking; and
5) the computer end counting and displaying answering results of the mobile ends.

2. The computer and mobile end class interactive answering method based on the two-dimensional code of claim 1, wherein the web page is generated through a normal web page editor, and the interactive question displayed on the computer screen can be a true or false question, choice question with single correct option or choice question with multiple correct options.

3. The computer and mobile end classroom interactive answering method based on the two-dimensional code of claim 1, wherein the two-dimensional code is popped up through a specified button on the page and displayed on the computer screen.

4. The computer and mobile end classroom interactive answering method based on the two-dimensional code of claim 1, wherein the mobile ends acquire the two-dimensional code of the computer end through a two-dimensional code scanning application.

5. The computer and mobile end class interactive answering method based on the two-dimensional code of claim 4, wherein the two-dimensional code scanning application is WeChat, MicroBlog, built-in RichScan or any other two-dimensional code scanning application.

6. The computer and mobile end classroom interactive answering method based on the two-dimensional code of claim 1, wherein the mobile ends are mobile phones or PADs.

7. A computer and mobile end classroom interactive answering device based on a two-dimensional code for implementing claim 1, comprising a computer end, mobile ends and a communication network, wherein the mobile ends are connected with the computer end through the communication network, the computer ends are provided with a teaching-used web page having question and answer option buttons and a two-dimensional code including the address of the web page, and the mobile ends are provided with a two-dimensional code scanning application for acquiring web page information of the computer end and answering a question on the web page online.

8. The computer end and mobile end classroom interactive answering device based on the two-dimensional code of claim 7, wherein the communication network is internet.
